(19) United States
(12) Patent Application Publication
(10) Pub. No.: US 2013/0010008 A1
(43) Pub. Date: Jan. 10, 2013

(54) DISPLAY APPARATUS AND METHOD FOR DRIVING THE SAME

(75) Inventors: Joon-hyun YANG, Suwon-si (KR); Kang-hyun YI, Yesan-gun (KR); Kang-wook CHUN, Seongnam-si (KR)

(73) Assignee: SAMSUNG ELECTRONICS CO., LTD., Suwon-si (KR)

(21) Appl. No.: 13/542,161

(22) Filed: Jul. 5, 2012

(30) Foreign Application Priority Data
Jul. 5, 2011 (KR) 2011-0066478

(51) Int. Cl. G09G 3/32; G09G 5/00; G09G 5/02

(52) U.S. Cl. 345/690; 345/212; 345/76

(57) ABSTRACT

A display apparatus is disclosed. The display apparatus includes a display portion including a plurality of pixels; a voltage driving portion that provides voltages to the plurality of pixels; and a control portion which controls the voltage driving portion to provide the voltages to the plurality of pixels, each of the voltages corresponding to a characteristic of a respective type of pixel of the plurality of pixels.

### CROSS-REFERENCE TO RELATED APPLICATIONS

This application claims the priority under 35 U.S.C. §119(a) from Korean Patent Application No. 10-2011-0066478 filed Jul. 5, 2011 in the Korean Intellectual Property Office, the disclosure of which is hereby incorporated herein by reference in its entirety.

### BACKGROUND

1. Field

The exemplary embodiments relate to a display apparatus and a method for driving the display apparatus, and more particularly, to an organic electroluminescence display apparatus and a method for driving the display apparatus.

2. Description of the Related Art

Generally, an organic electroluminescence display apparatus is a display apparatus which uses organic light emission devices using a light emission of organic materials to present an image by voltage driving or current driving N×M organic light emission cells arranged in a matrix form. The organic light emission cell has the diode characteristic so it is referred to as an organic light emission diode (hereinafter, referred to an organic light emission device (OLED), and has a structure configured of an anode electrode layer, an organic thin film, and a cathode electrode layer.

Each organic light emission device may have a different light emission efficiency corresponding to a color which the organic light emission device displays. Generally, an organic light emission device displaying green has the highest light emission efficiency, and then, organic light emission devices displaying red and blue respectively have lower light emission efficiencies. Hereinafter, green, red and blue are referred to G, R, and B, respectively.

On the other hand, a power source supplying an image displaying section with energy is an EL (Electroluminescent) power source. The level of the EL power source is generally determined by a current/voltage characteristic of a TFT (Thin Film Transistor) and a current/voltage characteristic of an OLED EL device.

Accordingly, since the EL voltage level is designed to satisfy the worst voltage characteristic among the R/G/B pixels and all the R/G/B pixels are driven by the same EL driver, there is a problem in that the OLED and TFT characteristic of each of the R/G/B pixels is not satisfied.

For example, in the B (blue), a voltage of 12V is needed for a current of 10 A to flow, consuming 120 W. However, in the G (green), a voltage of 9V is required for a current of 10 A to flow, consuming only 90 W. Since the EL voltage level is designed to satisfy the worst voltage characteristic, 12V, 12V is applied to G causing an actual consumption of 120 W. Therefore, in the G, an electric power of 30 W is consumed without being actually used. Also, when the brightest areas on a screen are very small, the EL voltage level of the other area of the screen is set high like that of the brightest areas causing the electric power to be consumed unnecessarily.

### SUMMARY

The exemplary embodiments have been developed in order to overcome the above drawbacks and other problems associated with a conventional arrangement of a display apparatus. An aspect of the exemplary embodiments relates to a display apparatus including a plurality of voltage driving modules providing different, separate, and/or independent driving voltages and a driving method thereof.

The above aspect and/or other features of the exemplary embodiments can substantially be achieved by providing a display apparatus, which may include a display portion including a plurality of RGB pixels; a voltage driving portion which has three voltage driving modules each corresponding to R pixels, G pixels, and B pixels of the RGB pixels, respectively; and a control portion controlling the three voltage driving modules to provide different, separate, and/or independent driving voltages to the R pixels, G pixels and B pixels.

The RGB pixels may include a self-emission device.

The RGB pixels may include an organic light emission device (OLED).

The RGB pixels may include a self-emission device, an ELVDD (Electroluminescent Driving Voltage) for supplying current to the self-emission device and a driving transistor for controlling the current being supplied to the self-emission device.

The three voltage driving modules may provide the driving voltage to three ELVDDs corresponding to each of the R pixels, G pixels and B pixels.

The control portion may control the three voltage driving modules to provide different driving voltages according to a current/voltage characteristic of each of the R pixels, G pixels and B pixels.

The control portion may provide the driving voltage according to the current/voltage characteristic of each of the R pixels, G pixels and B pixels by referring to a pre-stored lookup table.

The display apparatus is divided into a plurality of areas and the voltage driving module may include a plurality of sub voltage driving modules, the sub voltage driving modules corresponding to the plurality of areas, respectively.

The control portion may control a driving voltage level of the sub voltage driving module by referring to information of an input image.

The information of the input image may include at least one of brightness information and gradation information of the input image.

According to another aspect of the exemplary embodiments, a display apparatus may include a display portion including a plurality of pixels; a voltage driving portion which includes a plurality of voltage driving modules operating separately and provides driving voltage to the display portion; and a control portion controlling the voltage driving portion so that the plurality of voltage driving modules provide different driving voltages according to predetermined information.

The display apparatus may include a data driving portion which transmits data signals to the plurality of pixels; and a scan driving portion which transmits scan signals to the plurality of pixels, wherein the plurality of pixels emit light by driving current associated with a first voltage and a second voltage being provided by the voltage driving portion according to the data signals and the scan signals, and the control portion controls the plurality of voltage driving modules to provide the first and the second voltages at least one of which may be different according to the predetermined information.

The voltage driving portion may include three voltage driving modules corresponding to each of R, G, and B pixels, and the control portion may control the three voltage driving modules each providing the first and second voltage, at least one first and second voltage may be different from the others according to a current/voltage characteristic of each of the R, G, and B pixels.

The current/voltage characteristics of each of the R, G, and B pixels may be prestored in the form of a lookup table.

The voltage driving portion may include a plurality of voltage driving modules corresponding to each area of the display portion which is divided into a plurality of areas, and the control portion may control the plurality of voltage driving modules to provide the first voltage and the second voltage at least one of which may be different according to a screen information of each of the plurality of areas.

Each of the plurality of voltage driving modules corresponding to each of the areas of the display portion may include three voltage driving modules to provide each of R, G, and B pixels with the first voltage and the second voltage at least one of which may be different.

The display apparatus may include an organic electroluminescence display apparatus.

According to another aspect of the exemplary embodiments, a driving method of a display apparatus which includes a display portion including a plurality of pixels and a voltage driving portion that includes a plurality of voltage driving modules operating separately and providing driving voltage to the display portion, the driving method may include: determining the driving voltage which each of the plurality of voltage driving modules provides according to predetermined information; and controlling the plurality of voltage driving modules to provide different, separate, and/or independent driving voltages according to the determined driving voltage.

The display apparatus may include a data driving portion which transmits data signals to the plurality of pixels and a scan driving portion which transmits scan signals to the plurality of pixels, wherein the plurality of pixels emits light by driving current associated with a first voltage and a second voltage being provided by the voltage driving portion according to the data signals and the scan signals, and in the controlling the plurality of voltage driving modules the plurality of voltage driving modules are controlled to provide the first and second voltages, wherein at least one first and second voltage may be different from the others.

The voltage driving portion may include three voltage driving modules corresponding to each of R, G, and B pixels, and in the controlling the plurality of voltage driving modules, the three voltage driving modules are controlled to provide the first and second voltages, wherein at least one first and second voltage may be different according to a current/voltage characteristic of each of the R, G, and B pixels.

The current/voltage characteristic of each of the R, G, and B pixels may be prestored in the form of a lookup table.

The voltage driving portion may include a plurality of voltage driving modules corresponding to each area of the display portion which is divided into a plurality of areas, and in the controlling the plurality of voltage driving modules, the plurality of voltage driving modules may be controlled to provide the first and second voltages, wherein at least one first and second voltage may be different according to screen information of each of the plurality of areas.

Each of the plurality of voltage driving modules corresponding to each of the areas of the display portion may include three voltage driving modules to provide each of R, G, and B pixels with the first and second voltage, wherein at least one first and second voltage of one of the plurality of voltage driving modules may be different from the others.

The display apparatus may include an organic electroluminescence display apparatus.

According to another aspect of the exemplary embodiments, a recordable medium may include a program code which is stored in the recordable medium and executes a driving method of a display apparatus which comprises a display portion including a plurality of pixels and a voltage driving portion that comprises a plurality of voltage driving modules operating separately and provide driving voltages to the display portion. The driving method of the display apparatus may include determining the driving voltages which the plurality of voltage driving modules provide according to predetermined information; and controlling the plurality of voltage driving modules to provide different, separate, and/or independent driving voltages according to the determined driving voltages.

Therefore, the power consumption of a display apparatus may be reduced.

Other objects, advantages and salient features of the exemplary embodiments will become apparent from the following detailed description, which, taken in conjunction with the drawings, discloses the inventive concept.

### BRIEF DESCRIPTION OF THE DRAWINGS

These and/or other aspects and advantages of the exemplary embodiments will become apparent and more readily appreciated from the following description of the exemplary embodiments, taken in conjunction with the accompanying drawings of which:

FIG. 1 is a view illustrating a configuration of a display apparatus according to an exemplary embodiment;

FIG. 2A is a view for schematically explaining a circuit configuration of a display apparatus according to an exemplary embodiment;

FIG. 2B is a view for explaining a circuit configuration of a pixel according to an exemplary embodiment;

FIG. 3A is a circuit diagram for explaining a configuration of a voltage driving module according to an exemplary embodiment;

FIG. 3B is a timing diagram of a voltage driving portion according to an exemplary embodiment;

FIGS. 4A to 4C are views for explaining configurations of voltage driving portions according to various exemplary embodiments;

FIG. 5 is a view for explaining a voltage driving control method according to an exemplary embodiment

FIGS. 6A to 6E are views for explaining exemplary embodiments that adjust voltage according to a RGB gray-level of the exemplary embodiments;

FIGS. 7A and 7B are views for explaining effect according to an exemplary embodiment; and

FIG. 8 is a flow chart for explaining a method for driving a display apparatus according to an exemplary embodiment.

Throughout the drawings, like reference numerals will be understood to refer to like parts, components and structures.

### DETAILED DESCRIPTION OF THE EXEMPLARY EMBODIMENTS

Hereinafter, certain exemplary embodiments will be described in detail with reference to the accompanying drawings.

The exemplary embodiments described herein, such as a detailed construction and elements thereof, are provided to assist in a comprehensive understanding of this description. Thus, it would be appreciated by those of skill in the art that changes may be made to these embodiments without departing from the principles and spirit of the inventive concept. Also, well-known functions or constructions are omitted to provide a clear and concise description of exemplary embodiments. Further, dimensions of various elements in the accompanying drawings may be arbitrarily increased or decreased for assisting in a comprehensive understanding.

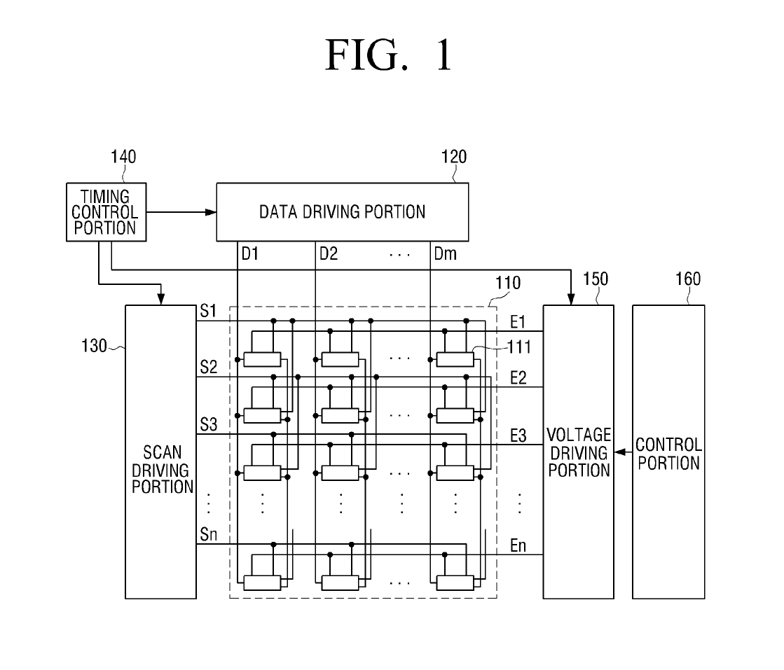

FIG. 1 is a view illustrating a configuration of a display apparatus according to an exemplary embodiment.

Referring to FIG. 1, a display apparatus according to an exemplary embodiment includes a display portion 110, a data driving portion 120, a scan driving portion 130, a timing control portion 140, a voltage driving portion 150 and a control portion 160. Here, the display apparatus may be embodied by an organic electroluminescence display apparatus.

A plurality of pixels 111 is arranged in the display portion 110. Each pixel 111 may include a self-emission device to emit light corresponding to a current flow, an ELVDD to supply current to the self-emission device and a driving transistor to control current being supplied to the self-emission device. Here, the self-emission device may be an organic light emission diode.

Also, the display portion 110 may be formed in an array to have n pieces of scan lines S1, S2, S3, . . . , and Sn which may be arranged in a row direction thereof and transmit scan signals, n pieces of voltage driving lines E1, E2, E3, . . . , and En which may be arranged in a row direction thereof and drive voltages, and m pieces of data lines D1, D2, D3, . . . , and Dm which may be arranged in a column direction thereof and transmit data signals.

Further, the display portion 110 may be supplied with at least a first voltage and a second voltage from the voltage driving portion 150 to be driven. Here, the first voltage may be a driving voltage ELVDD and the second voltage may be a base voltage ELVSS. For example, when current flows in the organic light emission diodes by scan signals, data signals, the driving voltage ELVDD, and the base voltage ELVSS, the display portion 110 emits light corresponding to the amount of the current to display images.

The data driving portion 120 generates data signals and receives image signals (R, G, B data) having red, blue and green components to generate data signals. Also, the data driving portion 120 is connected with the data lines D1, D2, D3, . . . , and Dm of the display portion 110 and applies the generated data signals to the display portion 110.

The scan driving portion 130 generates scan signals. The scan driving portion 130 is connected with the scan lines S1, S2, S3, . . . and Sn and transmits the scan signal to a specific row of the display portion 110. The data signal output from the data driving portion 120 is transmitted to the pixel 111 to which the scan signal was transmitted.

The timing control portion 140 receives an input signal IS, a horizontal sync signal Hsync, a vertical sync signal Vsync, a main clock signal MCLK, etc. from outside, generates an image data signal, a scan control signal, a data control signal, a light-emission control signal, etc. and can provide them to the display portion 110, the data driving portion 120, the scan driving portion 130, the voltage driving portion 150, etc.

The voltage driving portion 150 generates a driving voltage for each of the display portion 110, the data driving portion 120, the scan driving portion 130, etc and transmits the driving voltage to them. The driving voltage being transmitted to the display portion 110 may be the first voltage ELVDD and the second voltage ELVSS as described above.

On the other hand, the voltage driving portion 150 may include a plurality of voltage driving modules which operate individually. Here, the plurality of voltage driving modules can operate to provide different, separate, and/or independent voltages according to control of the control portion 160. The control portion 160 can control the voltage driving portion 150 so that the plurality of voltage driving modules provide different, separate, and/or independent driving voltages according to the predetermined information.

For example, each of the plurality of voltage driving modules can provide a different, separate, and/or independent first voltage from the other voltage driving modules according to the predetermined information and the second voltage set by default according to the control of the control portion 160. Here, the second voltage set by default may be a ground voltage.

According to an exemplary embodiment, the voltage driving portion 150 may include three voltage driving modules corresponding to each of R, G, and B pixels.

For example, the control portion 160 can control the three voltage driving modules to provide the different, separate, and/or independent first voltages, namely, different, separate, and/or independent ELVDD voltages depending on current/voltage characteristic of each of the R, G, and B pixels. Here, the current/voltage characteristic of each of the R, G, and B pixels may be prestored in the form of a lookup table. A detailed explanation thereof will be described with reference to drawings, hereinafter.

According to another exemplary embodiment, the display portion 110 may be divided into a plurality of areas and the voltage driving portion 150 may include a plurality of voltage driving modules corresponding to each of the plurality of areas of the display portion 110.

For example, the control portion 160 can control the plurality of voltage driving modules to provide different, separate, and/or independent first voltages, namely, different, separate, and/or independent ELVDD voltages depending on a screen information (or input image information) of each of the plurality of areas. For example, the control portion 160 can control the magnitude of the ELVDD voltage by using the image signals being input into the data driving portion 120. Here, the screen information may be at least one of brightness information and gradation information of the input images.

According to another exemplary embodiment, each of the plurality of voltage driving modules corresponding to each of the areas of the display portion 110 may include three voltage driving modules which may provide a different, separate, and/or independent first voltages, namely, different, separate, and/or independent ELVDD voltages to each of the R, G, and B pixels.

On the other hand, in this exemplary embodiment, although the configuration shows the control portion 160 separate from the timing control portion 140 as has been explained, this is only one example. Therefore, the control portion 160 may be embodied as a function of the timing control portion 140.

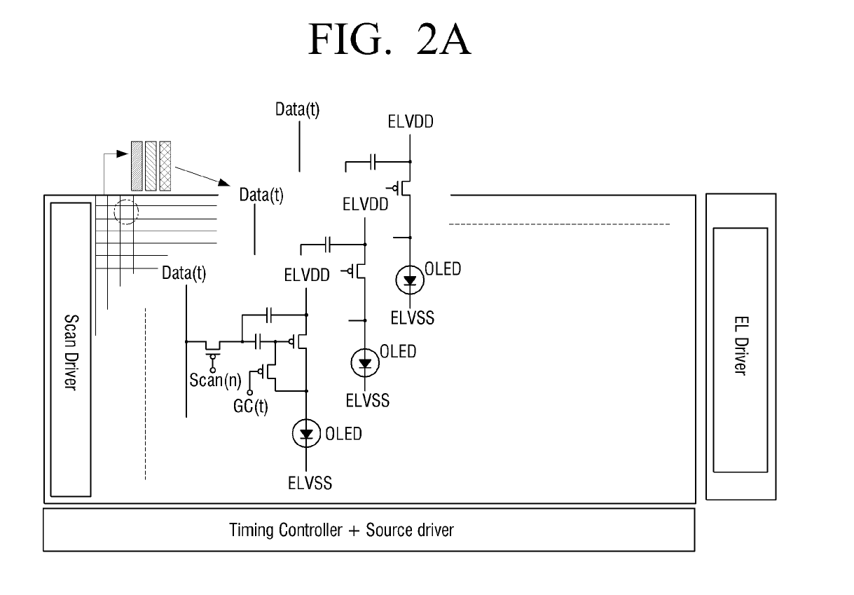

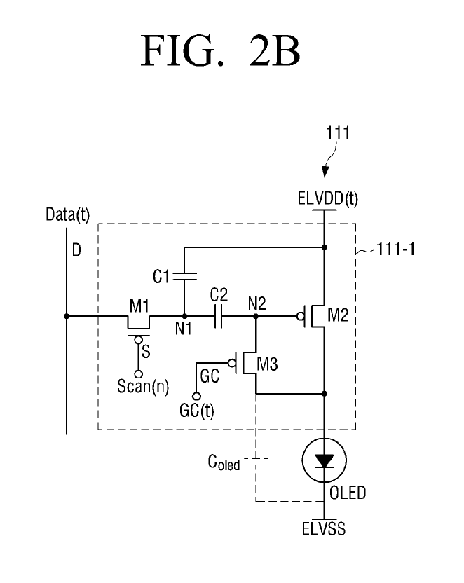

FIG. 2A is a view for schematically explaining a circuit configuration of a display apparatus according to an exemplary embodiment.

The display apparatus as illustrated in FIG. 2A may be embodied as an Active Matrix Organic Light-Emitting Diode (AM-OLED) panel. Here, the organic light-emitting diode OLED refers to a display which emits light by itself by the principle of electroluminescence when current flows in a fluorescent or phosphorescent organic thin film. Also, a Passive Matrix Organic Light-Emitting Diode (PM-OLED) uses a method for all light emitting devices of one line to be driven at the same time to emit light, whereas the AM-OLED uses a method for the light emitting devices to be driven individually.

As illustrated in FIG. 2A, the AM-OLED panel may be configured of RGB pixel cells which consist of TFT components and organic EL components. Here, the TFT component is driven by a Timing Controller, a Scan Driver, and a Source Driver and performs functions, such as to writing image information that is to be displayed, etc.

Also, the TFT inside the pixel drives the Active Matrix. Vth (Threshold Voltage) compensation and Data writing are performed by an external switch. Further, when light is actually emitted, the external switch is connected with a power source and then supplies the energy needed for light-emission.

FIG. 2B is a view for explaining a circuit configuration of a pixel according to an exemplary embodiment.

Referring to FIG. 2B, a pixel 111 according to an exemplary embodiment includes an organic light emission diode OLED and a pixel circuit 111-1 for supplying current to the OLED.

An anode electrode of the OLED is connected with the pixel circuit 111-1 and a cathode electrode is connected with a second power source ELVSS. The OLED generates light having a certain brightness corresponding to the current supplied from the pixel circuit 111-1.

As illustrated in FIG. 2B, the pixel circuit 111-1 which is included in each of the pixels 111 may include three transistors M1, M2 and M3 and two capacitors C1 and C2.

Here, a gate electrode of a first transistor M1 is connected with the scan line S and a first electrode is connected to the data line D. A second electrode of the first transistor M1 is connected with a first node N1.

For example, the scan signal Scan (n) is input into the gate electrode of the first transistor and the data signal Data (t) is input into the first electrode.

Also, a gate electrode of a second transistor M2 is connected with a second node N2, a first electrode thereof is connected with the first power source ELVDD (t), and a second electrode thereof is connected with the anode electrode of the OLED. Here, the second transistor M2 is served as a driving transistor.

Also, a first capacitance device C1 is connected between the first node N1 and the first electrode of the second transistor M2, namely, the first power source ELVDD (t). A second capacitance device C2 is connected between the first node N1 and the second node N2.

Also, a gate electrode of a third transistor M3 is connected with a control line GC, a first electrode thereof is connected to the gate electrode of the second transistor M2, and a second electrode thereof is connected with the anode electrode of the OLED, that is, the second electrode of the second transistor M2.

Accordingly, a control signal GC (t) is input into the gate electrode of the third transistor M3. When the third transistor M3 is turned on, the second transistor M2 is connected with the diode.

Also, a cathode electrode of the OLED is connected with the second power source ELVSS (t).

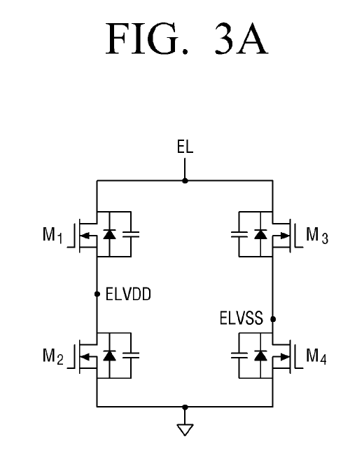

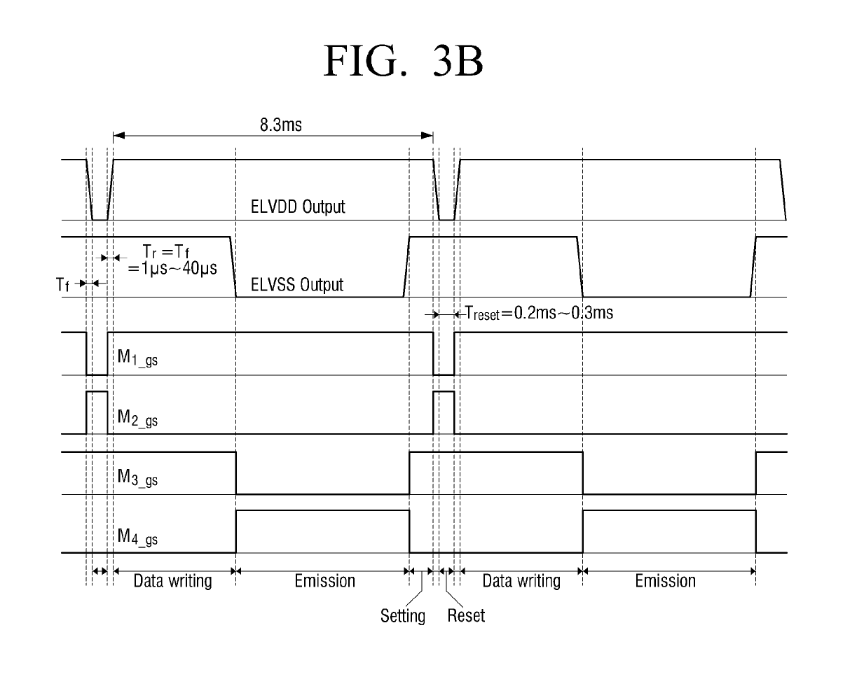

FIG. 3A is a circuit diagram for explaining a configuration of a voltage driving module according to an exemplary embodiment

As illustrated in FIG. 3A, the voltage driving module according to an exemplary embodiment is configured of four transistors M1, M2, M3 and M4 and can provide ELVDD voltage and ELVSS voltage.

FIG. 3B is a timing diagram of a voltage driving portion according to an exemplary embodiment.

As shown in the waveforms illustrated in FIG. 3B, EL voltage is applied to ELVDDout and ELVSSout by switching operation of an external EL driver. When both the ELVDDout and the ELVSSout are EL voltage, data is written on the OLED panel so that information to be displayed is written thereon. After that, when the ELVDDout is EL voltage and the ELVSSout is changed to Ground, current flows in an OLED so that images are displayed.

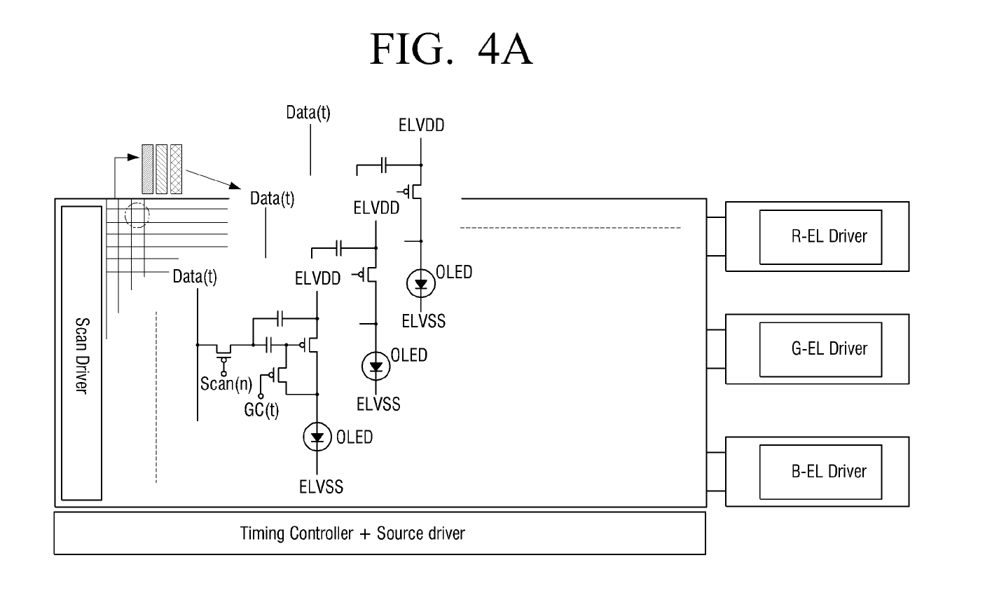

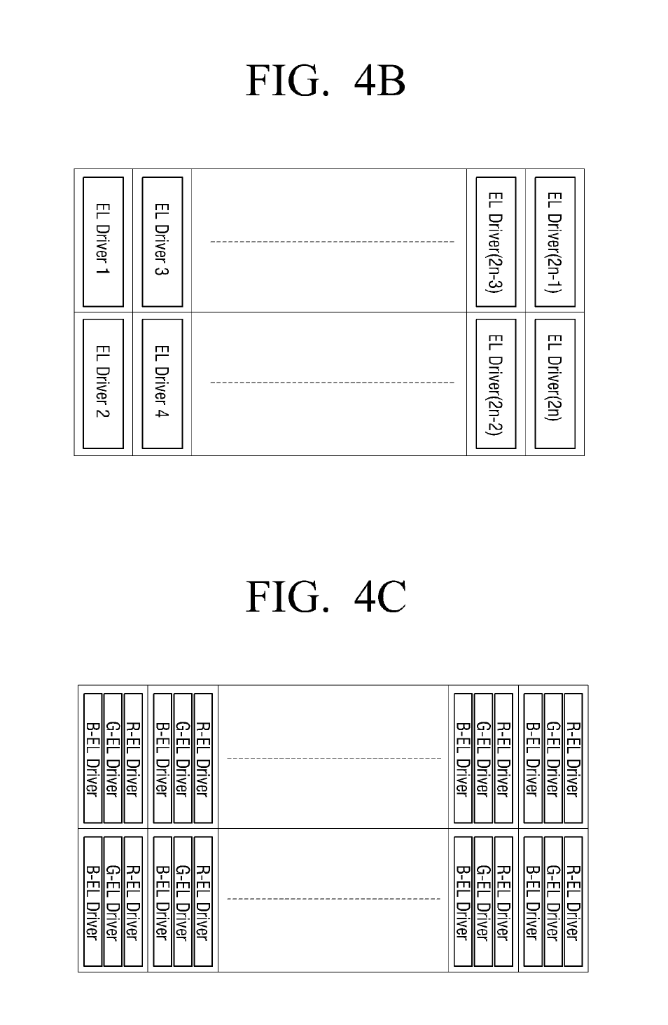

FIGS. 4A to 4C are views for explaining configurations of voltage driving portions according to various exemplary embodiments.

As illustrated in FIG. 4A, a plurality of voltage driving modules which constitute the voltage driving portion may be embodied as three voltage driving modules R-EL Driver, G-EL Driver, and B-EL Driver corresponding to each of R, G and B pixels.

For example, if each of R, G, and B pixels is driven by different R, G, B individual EL driving voltages according to a current/voltage characteristic of each of the R, G, and B pixels, power consumption may be reduced. Detailed reasons thereof will be described hereinafter with reference to drawings.

As illustrated in FIG. 4B, a plurality of voltage driving modules which constitutes the voltage driving portion may be embodied as a plurality of voltage driving modules EL Driver 1, EL Driver 2, . . . EL Driver 2n corresponding to each of areas of the display panel which is divided into a plurality of areas 2n.

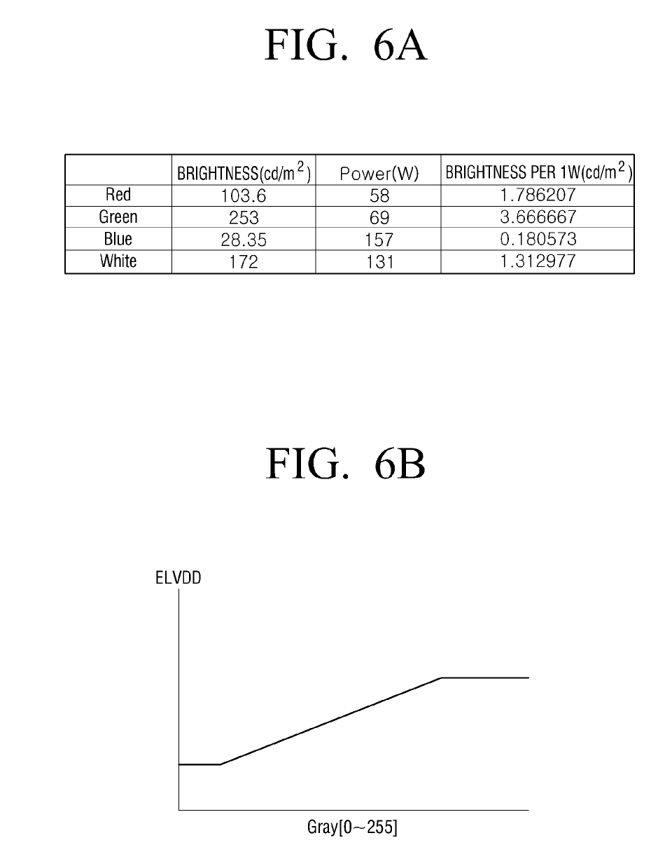

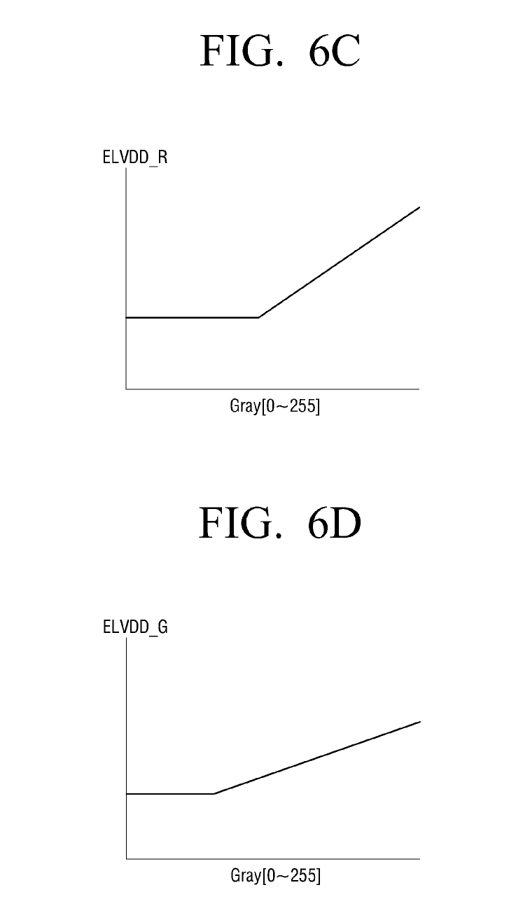

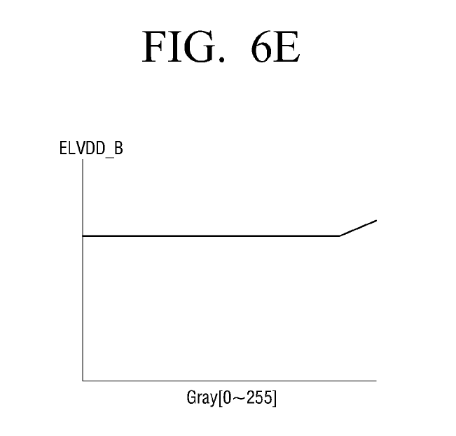

For example, different EL voltages may be provided according to screen information of each of the plurality of areas 2n. As illustrated in FIGS. 6A to 6E, since each of R/G/B/W needs a different EL voltage, if each of the R/G/B/W is driven by an EL voltage which is changed according to screen information, or at least one of brightness information and gradation information, of the input images rather than providing a fixed EL voltage. Therefore, power consumption may be reduced.

As illustrated in FIG. 4C, each of the plurality of voltage driving modules as illustrated in FIG. 4B may be formed to have three voltage driving modules R-EL Driver, G-EL Driver and B-EL Driver corresponding to each of R, G, and B pixels.

If the exemplary embodiment as illustrated in FIG. 4A and the exemplary embodiment as illustrated in FIG. 4B are duplicated, power consumption may be further reduced.

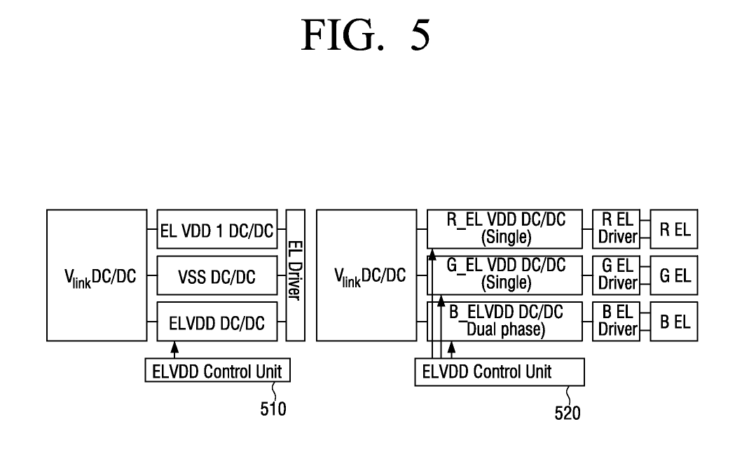

FIG. 5 is a view for explaining a voltage driving control method according to an exemplary embodiment.

As illustrated in FIG. 5, an ELVDD control unit (510 or 520) controls an ELVDD DC/DC converter to reduce power consumption to drive an EL Driver.

FIGS. 6A to 6E are views for explaining exemplary embodiments to adjust voltage according to RGB gray-level according to an exemplary embodiment.

Since as illustrated in FIG. 6A, each of R, G, and B pixels have a different current/voltage characteristic, if the three pixels are driven by the same voltage, in the R and G pixels unnecessary power consumption is generated. In other words, since the required EL voltage is different depending on the gray level, if the EL voltage is decreased as the gray level is reduced, the power consumption may be reduced.

After the data of FIGS. 6B to 6E is stored in the control portion 160 in the form of a look-up table, the voltage level associated with each of the R, G, and B pixels is adjusted according to screen information, and each of the R, G, and B pixels may be driven by the adjusted voltage level.

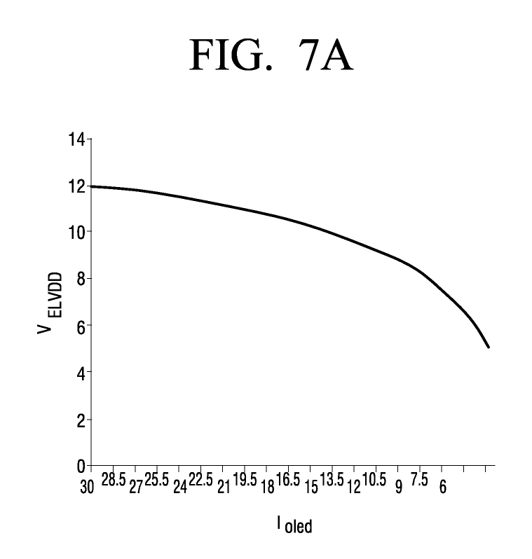

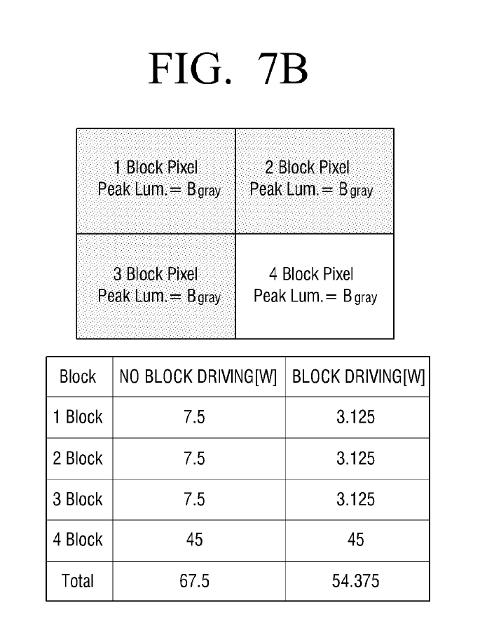

FIGS. 7A and 7B are views for explaining an effect according to an exemplary embodiment.

FIG. 7A is a graph illustrating a relationship between current and voltage of an OLED panel. FIG. 7B is a table for comparing the amount of power consumed when a block driving is performed according to an exemplary embodiment and the amount of power consumed when the block driving is not performed.

As illustrated in FIGS. 7A and 7B, when a simulation is performed by copying the current/voltage characteristic of the 40 inch OLED panel, it is found that 13 W of power is saved maximally when 4-block of R/G/B pixels are driven individually.

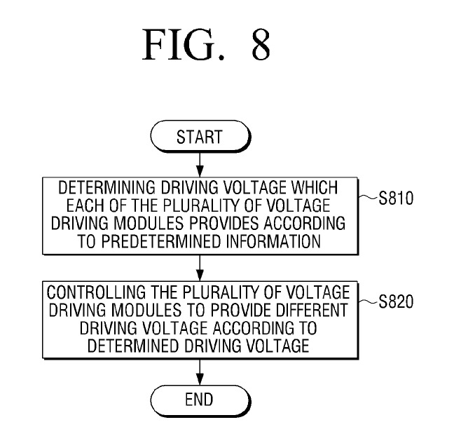

FIG. 8 is a flow chart for explaining a driving method of a display apparatus according to an exemplary embodiment.

The driving method of a display apparatus as illustrated in FIG. 8 may be a method for driving a display apparatus which includes a display portion having a plurality of pixels and a voltage driving portion which has a plurality of voltage driving modules that operate separately and provides driving voltage to the display portion. Here, the display apparatus may be an organic electroluminescence display apparatus.

According to the driving method of the display apparatus as illustrated in FIG. 8, the driving voltage, which each of the plurality of voltage driving modules that operate separately and/or independently according to predetermined information provide, is determined (S810).

Then, the plurality of voltage driving modules are controlled to provide different, separate, and/or independent driving voltages according to the determined driving voltage (S820).

Here, the display apparatus further includes a data driving portion to transmit data signals to the plurality of pixels and a scan driving portion to transmit scan signals to the plurality of pixels. The plurality of pixels may emit light by driving current associated with a first voltage and a second voltage which are provided by the voltage driving portion according to the data signals and scan signals.

For example, in the step S820, the plurality of voltage driving modules may be controlled to provide the first and second voltages, wherein at least one of the first and second voltages may be different from the others.

Also, the voltage driving portion may include three voltage driving modules corresponding to each of R, G, and B pixels.

For example, in step S820, the three voltage driving modules may be controlled to provide the first and second voltages, wherein at least one first and second voltage may be different from the other according to a current/voltage characteristic of each of R, G, and B pixels.

Here, the current/voltage characteristics of each of the R, G, and B pixels may be prestored in the form of a lookup table.

Also, the voltage driving portion may include a plurality of voltage driving modules corresponding to each area of the display portion which is divided into a plurality of areas.

For example, in the step S820, the plurality of voltage driving modules may be controlled to provide the first and second voltages, wherein at least one of the first and second voltages may be different from the others according to screen information of each of the plurality of areas.

Here, each of the plurality of voltage driving modules corresponding to each of the areas of the display portion may include three voltage driving modules to provide each of R, G, and B pixels with the first and second voltage, wherein at least one first and second voltage may be different from the others.

Accordingly, power consumption of the display apparatus may be reduced.

On the other hand, an exemplary embodiment may include a recordable medium that has a program code for executing a method for driving a display apparatus according to an exemplary embodiment. The computer readable recordable medium includes various types of recordable media in which data readable by computer systems can be stored. For example, the computer readable recordable media include a Read Only Memory (ROM), a Random Access Memory (RAM), a Compact Disc (CD)-ROM, a magnetic tape, a floppy disk, an optical data storing apparatus, etc. Also, the computer readable recordable media may be distributed in computer systems connected with each other through a network and a program code which the computer can read by a distributed processing method may be stored and executed therein

While the exemplary embodiments of the present inventive concept have been described, additional variations and modifications of the exemplary embodiments may occur to those skilled in the art once they learn of the basic inventive concepts. Therefore, it is intended that the appended claims shall be construed to include both the above exemplary embodiments and all such variations and modifications that fall within the spirit and scope of the inventive concepts.

What is claimed is:

1. A display apparatus comprising:
a display portion including a plurality of RGB pixels;
a voltage driving portion including three voltage driving modules corresponding to R pixel, G pixel and B pixel of the RGB pixels, respectively; and
a control portion controlling the three voltage driving modules to provide a different driving voltage to each of the R pixel, G pixel and B pixel.

2. The display apparatus of claim 1, wherein the RGB pixels comprises a self-emission device.

3. The display apparatus of claim 1, wherein the RGB pixels comprises an organic light emission device OLED.

4. The display apparatus of claim 1, wherein the RGB pixels comprise a self-emission device, an ELVDD for supplying current to the self-emission device and a driving transistor for controlling the current being supplied to the self-emission device.

5. The display apparatus of claim 1, wherein the three voltage driving modules provide the driving voltage to three ELVDDs corresponding to each of the R pixel, G pixel and B pixel.

6. The display apparatus of claim 1, wherein the control portion controls the three voltage driving modules to provide different driving voltage according to current/voltage characteristic of each of the R pixel, G pixel and B pixel.

7. The display apparatus of claim 6, wherein the control portion provides the driving voltage according to the current/voltage characteristic of each of the R pixel, G pixel and B pixel by referring to a pre-stored lookup table.

8. The display apparatus of claim 1, wherein the voltage driving module comprises a plurality of sub voltage driving modules,
the display apparatus is divided into a plurality of areas, and
the sub voltage driving modules correspond to the plurality of areas, respectively.

9. The display apparatus of claim 8, wherein the control portion determines a driving voltage level of the sub voltage driving module by referring to information of an input image.

10. The display apparatus of claim 9, wherein the information of the input image comprises at least one of brightness and gradation information of the input image.

11. A display apparatus, comprising:
a display portion including a plurality of pixels;
a voltage driving portion which includes a plurality of voltage driving modules operating separately and provides driving voltage to the display portion; and a control portion controlling the voltage driving portion so that the plurality of voltage driving modules provides different driving voltage according to predetermined information.

12. The display apparatus of claim 11, further comprising:
a data driving portion which transmits data signals to the plurality of pixels; and
a scan driving portion which transmits scan signals to the plurality of pixels, wherein the plurality of pixels emits light by driving current defined by first voltage and second voltage being provided by the voltage driving portion according to the data signals and the scan signals, and
wherein the control portion controls the plurality of voltage driving modules to provide the first voltage and the second voltage at least one of which is different according to the predetermined information.

13. The display apparatus of claim 12, wherein the voltage driving portion comprises three voltage driving modules corresponding to each of R, G, and B pixels, and
the control portion controls the three voltage driving modules to provide the first voltage and the second voltage at least one of which is different according to current/voltage characteristic of each of the R, G, and B pixels.

14. The display apparatus of claim 13, wherein, the current/voltage characteristic of each of the R, G, and B pixels is prestored in the form of a lookup table.

15. The display apparatus of claim 11, wherein the voltage driving portion comprises a plurality of voltage driving modules corresponding to each of areas of the display portion which is divided into a plurality of areas, and
the control portion controls the plurality of voltage driving modules to provide the first voltage and the second voltage at least one of which is different according to screen information of each of the plurality of areas.

16. The display apparatus of claim 15, wherein each of the plurality of voltage driving modules corresponding to each of the areas of the display portion comprises three voltage driving modules to provide each of R, G, and B pixels with the first voltage and the second voltage at least one of which is different.

17. The display apparatus of claim 11, wherein the display apparatus comprises an organic electroluminescence display apparatus.

18. A driving method of a display apparatus which comprises a display portion including a plurality of pixels and a voltage driving portion that comprises a plurality of voltage driving modules operating separately and provides driving voltage to the display portion, the driving method comprising:
determining the driving voltage which each of the plurality of voltage driving modules provides according to predetermined information; and
controlling the plurality of voltage driving modules to provide different driving voltage according to the determined driving voltage.

19. The driving method of claim 18, wherein the display apparatus further comprises a data driving portion which transmits data signals to the plurality of pixels and a scan driving portion which transmits scan signals to the plurality of pixels,
wherein the plurality of pixels emits light by driving current defined by first voltage and second voltage being provided by the voltage driving portion according to the data signals and the scan signals, and
wherein in the controlling the plurality of voltage driving modules, the plurality of voltage driving modules is controlled to provide the first voltage and the second voltage at least one of which is different.

20. The driving method of claim 19, wherein the voltage driving portion comprises three voltage driving modules corresponding to each of R, G, and B pixels, and
wherein in the controlling the plurality of voltage driving modules, the three voltage driving modules are controlled to provide the first voltage and the second voltage at least one of which is different according to current/voltage characteristic of each of the R, G, and B pixels.

21. The driving method of claim 20, wherein the current/voltage characteristic of each of the R, G, and B pixels is pre-stored in the form of a lookup table.

22. The driving method of claim 18, wherein the voltage driving portion comprises a plurality of voltage driving modules corresponding to each of areas of the display portion which is divided into a plurality of areas, and
wherein in the controlling the plurality of voltage driving modules, the plurality of voltage driving modules is controlled to provide the first voltage and the second voltage at least one of which is different according to screen information of each of the plurality of areas.

23. The driving method of claim 22, wherein each of the plurality of voltage driving modules corresponding to each of the areas of the display portion comprises three voltage driving modules to provide each of R, G, and B pixels with the first voltage and the second voltage at least one of which is different.

24. The driving method of claim 18, wherein the display apparatus comprises an organic electroluminescence display apparatus.

25. A recordable medium, comprising a program code which is stored in the recordable medium and executes a driving method of a display apparatus which comprises a display portion including a plurality of pixels and a voltage driving portion that comprises a plurality of voltage driving modules operating separately and provides driving voltage to the display portion, the driving method of the display apparatus comprising:
determining the driving voltage which the plurality of voltage driving modules provides according to predetermined information; and
controlling the plurality of voltage driving modules to provide different driving voltage according to the determined driving voltage.
